(19) United States
(12) Patent Application Publication
(10) Pub. No.: US 2025/0233536 A1
(43) Pub. Date: Jul. 17, 2025

(54) Method for Detecting Field Magnet Position of an Electric Motor

(71) Applicant: SHINANO KENSHI KABUSHIKI KAISHA, Nagano (JP)

(72) Inventor: Kazuteru SUZUKI, Nagano (JP)

(21) Appl. No.: 18/985,879

(22) Filed: Dec. 18, 2024

(30) Foreign Application Priority Data
Jan. 15, 2024 (JP) 2024-003718

(51) Int. Cl. H02P 6/185

(52) U.S. Cl. CPC H02P 6/185; H02P 2207/05

(57) ABSTRACT

An MPU calculates the motor current Im substituting a predetermined driving voltage V1, and an energization time t1 calculated from the PWM cycle and a predetermined duty ratio into Equation 1, calculates an energization time t2 substituting the motor current Im and a driving voltage V2 that has fluctuated from the driving voltage V1 into Equation 2, calculates and updates the duty ratio by dividing the energization time t2 by the PWM cycle, and applies the driving voltage V2 with the updated duty ratio from an inverter circuit to drive the motor.

### CROSS-REFERENCE TO RELATED APPLICATION

This application is based upon and claims the benefit of priority of the prior Japanese Patent Application No. 2024-003718, filed on Jan. 15, 2024, and the entire contents of which are incorporated herein by reference.

### TECHNICAL FIELD

The present disclosure relates to a method for detecting the field magnet position of an electric motor when the motor is operating at low speed.

### BACKGROUND ART

Although brushed DC motors are conventionally used as small direct current motors, problems relating to brush noise, electrical noise, and durability have led to the emergence of brushless DC motors. Attention has been focused more recently on sensorless motors, which do not have position sensors, from the perspectives of being smaller, lighter, more robust, and less costly. Sensorless motors were first used in hard disk drives and the like in the field of information equipment, and due to the development of vector control technology, adoption in the fields of home appliances and automobiles has also commenced.

During sensorless driving, the position of the rotor position is detected from an induced voltage. Since no induced voltage is generated when the motor is stationary, the rotor position is unknown and the motor cannot be started. To detect the rotor position when the motor is stationary, a coil current sensor and a current detection circuit are provided, an inverter is used to perform pulse wave modulation (hereinafter “PWM”) driving that supplies a sine wave-shaped coil current through the coil and the position is estimated from the current response. The rotor position when the motor is stationary can be detected from the deviation in inductance using the representative method described above. Alternatively, it is also possible, without sensing the position, to rotate the rotor by forced commutation so that the rotor position can be determined.

However, once a starting operation of the motor has commenced, a current will flow due to the rotation, which makes it difficult to use methods that apply sensing pulses to detect the rotor position from the deviation in inductance. As one example, although it would be conceivably possible to detect deviation in inductance by superimposing a high-frequency current onto the excitation current, doing so would have large hardware and software needs. It is also necessary to consider the influence of magnetic saturation and the induced voltage, with factors that are difficult to estimate, such as errors that are inherent to the motor and driving circuit, also being present. For this reason, it is common to perform a ramp start, where the rotor is forcibly positioned by fixed excitation without performing position detection before gradually increasing the rotation speed while achieving synchronization. However, this method takes a long time to position the rotor and also has a problem of reverse rotation. Since open loop control is used to achieve synchronization, it takes a long time to raise the motor speed and fluctuations in load can easily cause a loss of synchronization. To avoid this, driving is commenced with a large current, which reduces efficiency and increases the size of the DC power supply. Since synchronization is lost when the load fluctuates, this limits the range of potential applications, and this method cannot be used in reciprocating mechanisms or applications where rotation is caused by an external force, or in applications with a viscous load or a load that fluctuates.

For this reason, as a method for detecting magnetic field magnet position which can realize a low cost through use of simple hardware and software, there is a proposed method that detects the rotor position using changes in the induced voltage generated during non-energized phases according to the position of a permanent magnet field (that is, the rotor) when a voltage is applied to a motor during driving of a three-phase brushless motor with 120° energization (see Patent Document 1; Japanese Laid-open Patent Publication No. 2019-17235).

### SUMMARY OF INVENTION

### Technical Problem

However, when a motor is energized at 120° energization, the induced voltage generated during non-energized phases will change depending on the magnitude of the driving voltage supplied to the motor. When driving according to PWM in particular, the induced voltage will change depending on the magnitude of the duty ratio of the driving voltage (that is, the energization time).

FIG. 10 is a graph depicting changes in the induced voltage that is generated during non-energized phases of a motor according to rotational position of the rotor when the driving voltage fluctuates with a (fixed) duty ratio of 20%. From this graph, it can be seen that if voltage fluctuations occur, such as fluctuations in a battery system or power supply voltage, at a certain level or higher, the waveform of the induced voltage will change significantly, which can make it impossible to detect the field magnet position.

To eliminate this phenomenon, Patent Document 1 proposes a method of multiplying with a correction coefficient in keeping with the duty ratio. However, depending on the motor, even when the induced voltage is multiplied by a correction coefficient, position detection can still be difficult at low duty ratios of a certain level or lower or at high duty ratios at a certain level or higher. This means that this method can only be used for a limited range of duty ratios.

### Solution to Problem

The present disclosure was conceived to solve the above problems, and has an object of providing a method of detecting the field magnet position of an electric motor that can reliably detect the field magnet position of the motor and operate the motor at low speed even if the driving voltage fluctuates when low-speed sensorless driving of a three-phase brushless motor is performed according to PWM control with 120° energization.

A method according to an aspect of the present disclosure is a method for detecting the field magnet position of an electric motor, wherein the electric motor includes: a rotor with a permanent magnetic field; a stator including a three-phase coil; output section for bidirectionally energizing the three-phase coil via a half-bridge inverter circuit; control section for performing pulse width modulation (hereinafter “PWM”) control of a coil output in response to a command from a higher-level controller, storing energization angle information and energization direction information in units of 60° energization zones that enable continuous rotation, and for performing switching control of the output section based on the stored information to switch an energization state; and measuring section for performing analog to digital conversion of a three-phase coil voltage and sending the converted voltage to the control section, and the control section performs, through two-phase fixed energization via the output section, 120° energization, which periodically includes off cycles, in an energization direction where a position where self-excitation stops matches a start position of a 60° energization zone, to drive the motor in a sensorless manner while detecting a field magnet position of the motor through measurement by the measuring section of an energization phase voltage and a non-energization phase voltage during an on cycle during PWM energization, the method including: the control section calculating, when a driving voltage, which is applied to the three-phase coil with a predetermined duty ratio to drive the motor, has fluctuated and

$$Im = V / Rm ( 1 - {e}^{( - \frac{Rm}{Lm} )} t ) \qquad Equation 1$$

where an inductance of the motor is Lm, a resistance is Rm, a driving voltage is V, an energization time is t, and a motor current is Im, is satisfied, the motor current Im by substituting a predetermined driving voltage V1 and an energization time t1 calculated from a PWM cycle and a predetermined duty ratio into Equation 1; the control section using

$$t = ( Lm / Rm ) {log}_{e} ( - V / ImRm - V ) \qquad Equation 2$$

produced by solving Equation 1 for t to calculate an energization time t2 by substituting the motor current Im calculated by Equation 1 and a driving voltage V2 that has fluctuated from the driving voltage V1 into Equation 2; the control section calculating and updating the duty ratio by dividing the energization time t2 by the PWM cycle; and the control section using the output section to drive the motor by applying the driving voltage V2 with the updated duty ratio.

In this way, when the driving voltage fluctuates to V2 during low-speed operation through the application of a driving voltage V1 to the three-phase coil with a predetermined duty ratio,

$$Im = V / Rm ( 1 - {e}^{( - \frac{Rm}{Lm} )} t ) \qquad Equation 1$$

is used by the control section to substitutes a predetermined driving voltage V1 and the energization time t1 calculated from the PWM period and the predetermined duty ratio into Equation 1 to calculate the motor current Im. The control section uses

$$t = ( Lm / Rm ) {log}_{e} ( - V / ImRm - V ) \qquad Equation 2$$

produced by solving Equation 1 fort and substitutes the motor current Im calculated using Equation 1 and the driving voltage V2 that has fluctuated from the driving voltage V1 into Equation 2 to calculate the energization time t2, calculates and updates the duty ratio by dividing the energization time t2 by the PWM cycle, and applies the driving voltage V2 with the updated duty ratio from the using the output section. The measuring section then measures the energized phase voltage and non-energized phase voltage during an on cycle in the PWM energization to detect the magnetic field magnet position of the motor. This makes it possible to detect the field magnet position of the motor and perform low-speed driving without being affected by fluctuations in the driving voltage.

### Advantageous Effects of Invention

There is provided a method of detecting the field magnet position of an electric motor that can reliably detect, by updating the duty ratio, the field magnet position of the motor and operate the motor at low speed even if the driving voltage fluctuates when low-speed driving of a three-phase brushless motor is performed according to PWM control with 120° energization.

### BRIEF DESCRIPTION OF DRAWINGS

FIG. 1 is a waveform diagram of inductance and non-energized phase coil voltage during U-V excitation.

FIG. 2 is a waveform diagram of inductance and non-energized phase coil voltage during U-W excitation.

FIG. 3 is a waveform diagram of inductance and non-energized phase coil voltage during V-W excitation.

FIG. 4 is a waveform diagram of inductance and non-energized phase coil voltage during V-U excitation.

FIG. 5 is a waveform diagram of inductance and non-energized phase coil voltage during W-U excitation.

FIG. 6 is a waveform diagram of inductance and non-energized phase coil voltage during W-V excitation.

FIGS. 7A and 7B are actual waveform diagrams of non-energized phase coil voltage.

FIG. 8 is a block diagram of a driving circuit of a three-phase brushless DC motor.

FIG. 9 is a diagram depicting the configuration of a star-connected three-phase brushless DC motor.

FIG. 10 is a waveform diagram of an induced voltage induced in a non-energized phase coil when a driving voltage fluctuates with a fixed duty ratio of 20% during PWM driving.

FIG. 11 is a waveform diagram of an induced voltage induced in a non-energized phase coil when the duty ratio is corrected in keeping with voltage fluctuations from a driving voltage with a duty ratio of 20% during PWM driving.

### DESCRIPTION OF EMBODIMENTS

Preferred embodiments of a method for detecting the field magnet position of an electric motor according to the present disclosure are described below with reference to the attached drawings. As one example of an electric motor, the present disclosure will be described using a sensorless motor that has a permanent magnetic field provided the rotor, where windings in the stator are disposed at a phase difference of 120° in a star connection, and the phase ends are connected to a motor output section.

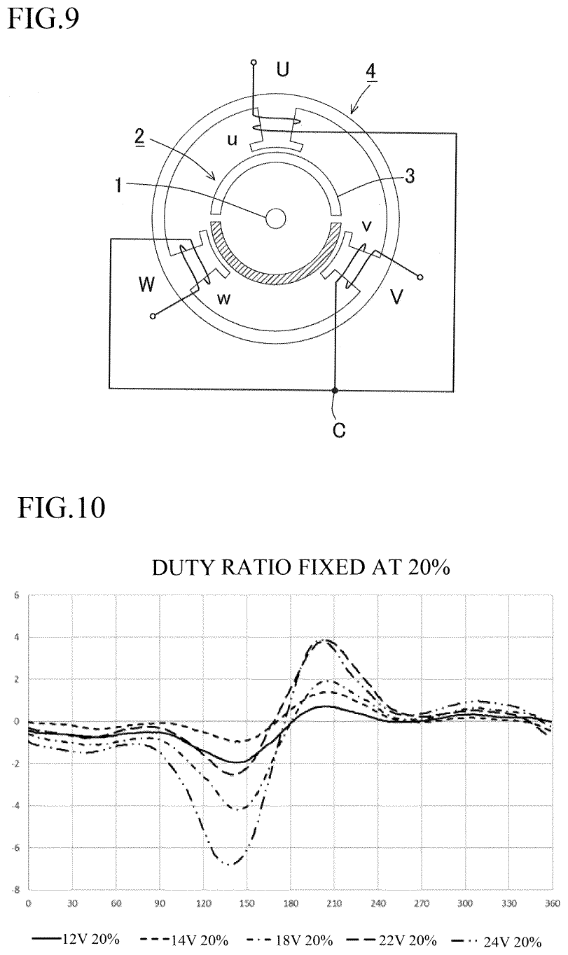

As one example, a method for detecting the position of the permanent magnetic field of a sensorless motor where a three-phase DC brushless motor is driven in a sensorless manner is described below together with the configuration of a sensorless motor driving device. One embodiment of a three-phase brushless DC motor according to the present disclosure will be described with reference to FIG. 9. In this example, a three-phase brushless DC motor equipped with a two-pole permanent magnet rotor and a three-slot stator 4 is depicted. The motor referred to here may be an inner-rotor motor or an outer-rotor motor. Regarding the permanent magnetic field, the motor may be an internal permanent magnet (IPM) motor or a surface permanent magnet (SPM) motor.

In FIG. 9, the rotor 2 is integrally provided on a rotor shaft 1, and a two-pole permanent magnet 3 is provided as a field magnet. The stator 4 has pole teeth U, V, and W disposed facing the permanent magnet 3 with a phase difference of 120° between them. Windings u, v, and w are provided on each of the pole teeth U, V, and W of the stator 4 and these phases are wired by a star connection to a common point C to produce a three-phase brushless DC motor that is wired to a motor driving device, described later. Note that common wires are unnecessary and therefore omitted here.

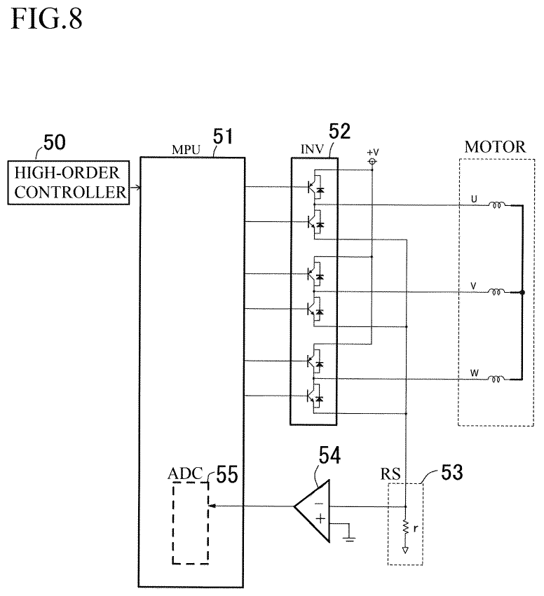

Next, one example of a driving circuit for a three-phase DC brushless motor is depicted in FIG. 8. Here, it is assumed that the driving method at motor startup is 120° bipolar square-wave excitation. “MOTOR” in the drawing represents a three-phase sensorless motor. “MPU 51” represents a microcontroller (or control section). The MPU 51 stores magnetic field magnet position information that specifies six energization directions for the three-phase coils (U, V, W) and excitation switching zones (“zone 1” to “zone 6”) for 120° energization corresponding to these energization directions, and can freely switch the excitation state through switching control of an output section in response to a rotation command from a higher-order controller 50.

An inverter circuit 52 (or “output section”, indicated as “INV”) energizes the three-phase coils and performs switching operations, such as excitation phase switching or PWM control, to control the torque of the motor. The inverter circuit 52 is provided with diodes connected in inverse parallel to switching elements, and is equipped with enough half-bridge switching circuits for three phases that can be freely connected to a positive power supply line and a ground power supply line. A current sensor 53 measures the coil current when a three-phase coil is energized according to PWM. In more detail, a shunt resistor r is provided between the shared ground terminal of the inverter circuit 52 and ground. Since a low voltage of only several volts, which is the voltage drop, is applied to the shunt resistor r, the shunt resistor r can be used even when the voltage applied to the coil is a high voltage of several hundred volts. An operational amplifier 54 amplifies a coil voltage which corresponds to the coil current and sends this voltage to an A/D conversion circuit 55 (or “measuring section”, marked as “ADC”).

The A/D conversion circuit 55 is connected to the coil output terminals U, V, and W and, in response to a conversion start signal from the MPU 51, simultaneously samples the coil voltages of each of the three phases, sequentially performs analog-to-digital conversion, and sends the conversion results to the MPU 51. The ADC 55 is normally built into the MPU 51, and when using a built-in ADC 55, it is desirable to provide a voltage divider circuit composed of resistors due to the low maximum input voltage. In this way, the driving circuit can use an extremely simple configuration.

It is known that a change in inductance (known as “space harmonics”) due to the rotor angle θ approximates to ΔL=−cos (2θ) and that there are two periods per electrical angle. On the other hand, it is also known that when a three-phase coil is energized using two-phase square wave PWM energization, during non-energized phases, a voltage fluctuation according to θ with two periods centered on the neutral point potential will be observed.

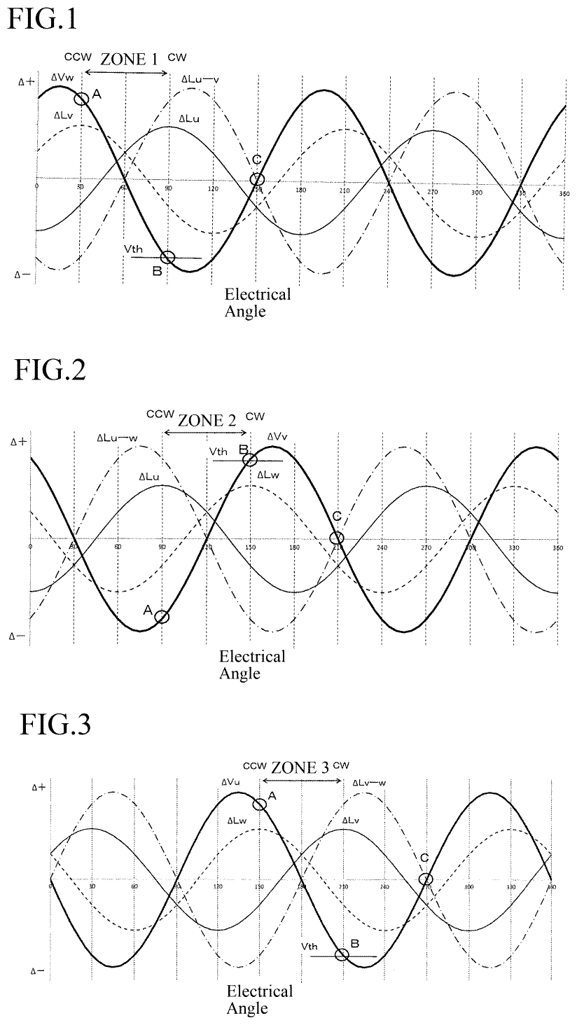

FIG. 1 depicts the voltage change waveform ΔVw during a non-energized phase, changes in inductance (ΔLu, ΔLv) during the U and V phases, and a theoretical waveform of the combined change in inductance ΔLu-v of the two phases when the motor has rotated by one electrical angle through U-V excitation according to PWM energization. Note that the voltage change waveform is the waveform of the combined change in inductance with the polarity inverted, and swings positive and negative around a neutral point potential that is half the voltage applied to the coil.

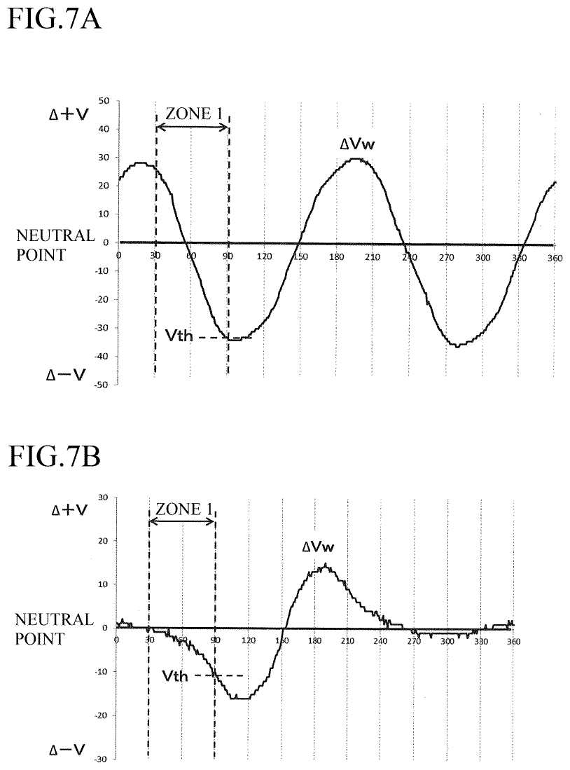

FIG. 7A depicts a measured waveform of the coil voltage during a non-energized phase when an inner rotor motor is used. It is assumed above that the theoretical voltage waveform during the non-energized phase will reflect the inductance with the opposite polarity, and since the waveforms are nearly identical, this proves that this assumption is correct. Although some ringing occurs in the induced voltage when a square wave current is applied, actual measurement shows that the ringing time is extremely short and converges within a measurement error range of a few to several tens of microseconds for a range of various motors, making it possible to accurately detect the induced voltage even when square-wave PWM current pulses are used to drive a motor.

When a large current flows through a three-phase coil, magnetic saturation occurs and the inductance will no longer change, which is particularly noticeable in small outer-rotor motors. When magnetic saturation occurs, the two-period waveform of the change in inductance will still have the peak and bottom that are adjacent to the setup position where the self-excitation due to two-phase fixed energization stops, but the other peak and bottom will disappear, resulting in a single-period waveform. FIG. 7B depicts an example of an inductance waveform that has a single period due to magnetic saturation. The motor used for this measurement was a small outer-rotor motor and differs from the motor used for FIG. 7A. The setup position for U-V energization is 150°, and in the ΔVw waveform, only the peak and bottom adjacent to the setup position are clearly observed.

The setup position where self-excitation due to two-phase fixed energization stops is both the zero-crossing point of the inductance and the zero-crossing point of the induced voltage, so that the setup position and the adjacent peaks and bottom are stable even when magnetic saturation occurs. As can be understood from FIGS. 7A and 7B, the voltage fluctuations during the non-energized phase reflect the rotor angle θ with monotonicity being maintained within this zone, so that even if no induced voltage is generated when the motor is at rest, it is possible to estimate the rotor position by applying an excitation current. The voltage fluctuation range is 10% or more of the voltage applied to the coil and of the order of several volts, which is clearly advantageous with respect to conventional methods considering that induced voltages of the order of millivolts are detected at motor start-up.

As explained above, by detecting changes in inductance for the coil voltage during a non-energized phase when square-wave PWM control is performed to drive a motor and using only changes in inductance near the setup position, position detection can be performed stably in a range from a stopped state to low-speed rotation. This simplifies the sensing procedure, improves efficiency since power is not required for sensing, and reduces noise since no sensing noise is generated.

The angle and energization direction for each energization zone when 120° energization is performed are collectively indicated in the table below. In the table, “CW current” indicates the energization direction when rotating in a direction where the angle increases and “CCW current” is the energization direction when rotating in the direction where the angle decreases. “Setup current” indicates the energization direction where self-excitation stops at the angle indicated in the ( ) brackets in the element in the table, with both the start and end points listed for each zone. For each current direction, the phase connected to the +power supply side is indicated first with the phase connected to the GND side listed after a hyphen.

TABLE 1
Zone angles and Energization directions

| Zone | | CW | CCW | Setup |
|---|---|---|---|---|
| number | Zone angle | current | current | current |
| 1 | 30° to 90° | U-V | V-U | W-U (30°) |
| | | | | W-V (90°) |
| 2 | 90° to 150° | U-W | U-W | W-V (90°) |
| | | | | U-V (150°) |
| 3 | 150° to 210° | V-W | W-V | U-V (150°) |
| | | | | U-W (210°) |
| 4 | 210° to 270° | V-U | U-V | U-W (210°) |
| | | | | V-W (270°) |
| 5 | 270° to 330° | W-U | U-W | V-W (270°) |
| | | | | V-U (330°) |
| 6 | 330° to 30° | W-V | V-W | V-U (330°) |
| | | | | W-U (30°) |

The rotation direction where the zone number in Table 1 increases is referred to as “CW”, and the rotation direction where the number decreases is referred to as “CCW”. The zone end position is the boundary point with the adjacent zone on the + side when rotating in the CW direction and the adjacent zone on the − side when rotating in the CCW direction. As one example, in the case of zone 1, the boundary point with zone 2 is 90° when rotating in the CW direction, and the boundary point with zone 6 is 30° when rotating in the CCW direction.

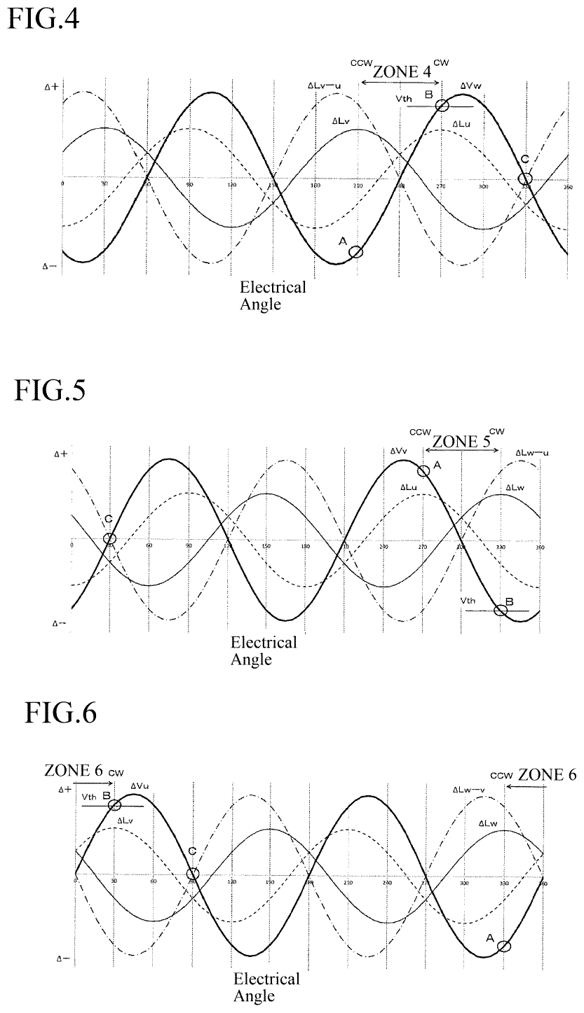

In FIG. 1, the start point of the energization flow zone when rotating in the CW direction with U-V excitation is indicated as “Point A”, and the end point of the energization flow zone is indicated as “Point B”. The setup point is Point C, and the bottom part where Point B is located has a stable phase and can be used for position detection. For this reason, positive and negative thresholds Vth with a predetermined potential difference from the neutral point potential are set in advance, the magnitude of the non-energized phase coil voltage ΔVw is compared with the threshold Vth whenever measurement is performed, and when the threshold is exceeded, it is detected that a zone end point has been crossed. Since V-U energization is performed when rotating in the CCW direction, refer to FIG. 4. The rotor rotates from an electrical angle of 90° toward an electrical angle of 30°. The zone end point is therefore at the electrical angle of 30°. Since the setup point is at an electrical angle of 330°, the bottom part on the 30° electrical angle side has a stable phase and can be used for position detection. This means that in the same way as during CW rotation, the zone end point can be detected by comparing the magnitude of the voltage of the non-energized phase W with the threshold Vth.

U-W excitation is selected in zone 2, which is from an electrical angle of 90° to an electrical angle of 150°. FIG. 2 depicts the change in inductance and the change in the non-energized phase coil voltage during U-W excitation. The waveforms here are the same as the waveforms in FIG. 1 but shifted by 60° and with the polarity inverted, the non-energized phase is V phase, and the setup position C is at an electrical angle of 210°. When the rotor is positioned in zone 2 and is rotating in the CW direction, the non-energized phase coil voltage will always pass through point B, so that the rotor position at that point is an electrical angle of 150° and by switching to zone 3 when point B has been detected, it will be possible to perform continuous rotation.

V-W excitation is selected in zone 3, which is from an electrical angle of 150° to an electrical angle of 210°. FIG. 3 depicts the change in inductance and the change in the non-energized phase coil voltage during V-W excitation. The waveforms here are the same as the waveforms in FIG. 2 but shifted by 60° and with the polarity inverted, the non-energized phase is U phase, and the setup position C is at an electrical angle of 270°. When the rotor is positioned in zone 3 and is rotating in the CW direction, the non-energized phase coil voltage will always pass through point B, so the rotor position at that point is an electrical angle of 210° and by switching to zone 4 when point B has been detected, it will be possible to perform continuous rotation.

V-U excitation is selected in zone 4, which is from an electrical angle of 210° to an electrical angle of 270°. FIG. 4 depicts the change in inductance and the change in the non-energized phase coil voltage during V-U excitation. The waveforms here are the same as the waveforms in FIG. 3 but shifted by 60° and with the polarity inverted, the non-energized phase is W phase, and the setup position C is at an electrical angle of 330°. When the rotor is positioned in zone 4 and rotating in the CW direction, the non-energized phase coil voltage will always pass through point B, so the rotor position at that point is an electrical angle of 270° and by switching to zone 5 when point B has been detected, it will be possible to perform continuous rotation.

W-U excitation is selected in zone 5, which is from an electrical angle of 270° to an electrical angle of 330°. FIG. 5 depicts the change in inductance and the change in the non-energized phase coil voltage during W-U excitation. The waveforms here are the same as the waveforms in FIG. 4 but shifted by 60° and with the polarity inverted, the non-energized phase is V phase, and the setup position C is at an electrical angle of 30°. When the rotor is positioned in zone 5 and rotating in the CW direction, the non-energized phase coil voltage will always pass through point B, so the rotor position at that point is an electrical angle of 330° and by switching to zone 6 when point B has been detected, it is possible to perform continuous rotation.

W-V excitation is selected in zone 6, which is from an electrical angle of 330° to an electrical angle of 30°. FIG. 6 depicts the change in inductance and the change in the non-energized phase coil voltage during W-V excitation. The waveforms here are the same as the waveforms in FIG. 5 but shifted by 60° and with the polarity inverted, the non-energized phase is U phase, and the setup position C is at an electrical angle of 90°. When the rotor is positioned in zone 6 and rotating in the CW direction, the non-energized phase coil voltage will always pass through point B, so the rotor position at that point is an electrical angle of 30° and by switching to zone 1 when point B has been detected, it is possible to perform continuous rotation.

In this way, the end point of a zone, which is positioned at a peak or bottom adjacent to the setup position, can be detected using a threshold set in advance. After this, when the non-energized phase coil voltage exceeds the threshold, the section number can be set to +1 during CW rotation and −1 during CCW rotation, which makes continuous rotation possible.

As described earlier, the rotation direction where the zone number increases is “CW”, and the rotation direction where the zone number decreases is “CCW”. The zone start position is the boundary point with the adjacent zone on the − (minus) side during CW rotation or the boundary point with the adjacent zone on the + (plus) size during CCW rotation. As one example, for the case of energization zone 1, the boundary point with energization zone 6 is 30° during CW rotation, and the boundary point with energization zone 2 is 90° during CCW rotation.

In FIG. 1, the start point of a zone when rotating in the CW direction with U-V energization is indicated as “point A”. During normal operation, the motor will rotate in the desired direction and there is no need to detect the start point of a zone, but when an external force has been applied that causes the motor to rotate at low speed in the opposite direction to the desired direction, it will be necessary to detect the start point so that the excitation can be switched correctly. When rotating at high speed, it will be necessary to perform braking to slow the motor down, so it is believed that detection of the start point position is only possible when rotating at low speed. When rotating in the opposite direction, the induced voltage will be problematic. In FIG. 1, the induced voltage during the non-energized phase W has a zero-cross point at an electrical angle of 60° in the middle of the zone. When rotating in the forward direction, the gradient due to the change in inductance and the gradient in the induced voltage will match, which makes it possible to reliably detect the end point of the zone. However, when rotating in the reverse direction, the two gradients are opposite and the waveform caused by the change in inductance will be cancelled out, making it difficult to detect the start point of the zone. Additionally, in the case of a motor that only has a single period due to magnetic saturation, it is almost impossible to detect the start point of a zone.

This means that if we focus on point C, the setup position for W-U excitation in FIG. 5, since point C passes through an electrical angle of 30°, by comparing the neutral point potential with the magnitude of the non-energized phase V-phase voltage ΔVv, when ΔVv becomes smaller than the neutral point potential, the rotor can be detected as having rotated past an electrical angle of 30° toward zone 6. Accordingly, during U-V excitation in zone 1, if the non-energized phase V-phase voltage is measured after switching to W-U excitation for an instant, it is possible to determine whether the electrical angle is just before or has passed 30°. If this measurement is repeated periodically until the electrical angle of 30° is passed, the start point of the zone, that is, the excitation switching position, can be detected.

When rotating in the CCW direction, the zone start point at an electrical angle of 90° can be detected in the same manner as when rotating in the CW direction. That is, W-V excitation is performed as depicted in FIG. 6 and the position of the electrical angle of 90° can be detected by measuring the non-energized phase U phase voltage. Before the setup positions at an electrical angle of 30° or an electrical angle of 90°, the gradient of the voltage change is steep, making it easy to determine whether the voltage is positive or negative, and there is little phase shift, which makes it possible to perform position detection reliably. Although small, since some power is consumed for sensing, it is desirable to extend the cycle at which sensing is performed.

In the same way, for energization zones 2 to 6, the start point of a zone can be detected by selecting the energization direction where the setup point is reached and periodically detecting the zero-crossing point for inductance. When the start point has been detected, this means that the motor is rotating in the reverse direction, and continuous rotation can be performed if the zone number is restored in the reverse direction.

In a case where an external force causes the rotor to rotate in the opposite direction to the desired direction at an extremely slow speed, to restore normal rotation, it is necessary to detect the start point of a zone and switch the excitation. The start point of a zone can be detected by setting a start point threshold. As one example, in FIG. 1, if the rotor is positioned in zone 1, the potential at point A can be set as the start point threshold. In the same way, for zones 2 to 6 in FIGS. 2 to 6, the potential at point A of each zone can be used as the start-point threshold. This means that it is possible to set a start-point threshold Vth2 with a specified potential difference with respect to the neutral point potential in advance, to compare the magnitude of the non-energized phase coil voltage ΔV with the start-point threshold Vth2 whenever measurement is performed, and to detect that the zone start point has been passed when the start-point threshold has been exceeded. The gradient of the non-energized phase coil voltage ΔV can also be determined, and if the gradient is opposite to the gradient during forward rotation, it is possible to detect that the motor is rotating in reverse.

Accordingly, if a start point is detected while the rotor is rotating in the reverse direction, performing excitation in an excitation zone that has been restored by one zone will generate forward torque, which is to say, will cause braking which suppresses the reverse rotation and restores forward rotation. However, since the polarity of the induced voltage during reverse rotation is opposite to the polarity during forward rotation, the non-energized phase coil voltage ΔV at the start point of the zone will be smaller than during forward rotation and will not exceed the start point threshold Vth2. In this case, it is possible to estimate the induced voltage by calculation and correct the start point threshold value Vth2. Alternatively, detection of the start point may be limited to only when the rotation speed is extremely low, at which time the error due to the induced voltage is negligible.

According to this method, a start point can be detected in an excitation state used for driving without performing any special excitation to detect the field magnet position. This means that there is no decrease in energization efficiency and no electromagnetic noise is generated due to application of a sensing current. In addition, by detecting the start point, it is possible to apply braking from reverse rotation and restore forward rotation.

The changes in the non-energized phase coil voltage will depend on the duty ratio of the driving voltage. When a motor is driven at a predetermined driving voltage with a constant duty ratio, if there are voltage fluctuations of a certain level or higher due to fluctuations in a battery system or the power supply voltage, the waveform of the induced voltage induced in the non-energized phase coil may change significantly as depicted in FIG. 10, which can make it impossible to detect the field magnet position. For this reason, as described below, a method is used where the duty ratio of the driving voltage applied to the three-phase coils is updated from the PWM cycle to enable detection of the field magnet position using the driving voltage applied from an output section.

When the driving voltage fluctuates and the motor inductance is expressed as Lm, the resistance is Rm, the driving voltage is V, and the energization time is t, the motor current Im satisfies Equation 1 below.

$$Im = V / Rm ( 1 - {e}^{( - \frac{Rm}{Lm} )} t ) \qquad Equation 1$$

The MPU 51 substitutes the predetermined driving voltage V1, and the energization time t1 calculated from the PWM cycle and the predetermined duty ratio into Equation 1 to calculate the motor current Im. The MPU 51 uses

$$t = ( Lm / Rm ) {log}_{e} ( - V / ImRm - V ) \qquad Equation 2$$

produced by solving Equation 1 for t and substitutes the motor current Im calculated using Equation 1 and the driving voltage V2 that has fluctuated from the driving voltage V1 into Equation 2 to calculate the energization time t2, calculates the duty ratio by dividing the energization time t2 by the PWM cycle, and applies the driving voltage V2 with the updated duty ratio from the inverter circuit 52 to perform low-speed driving.

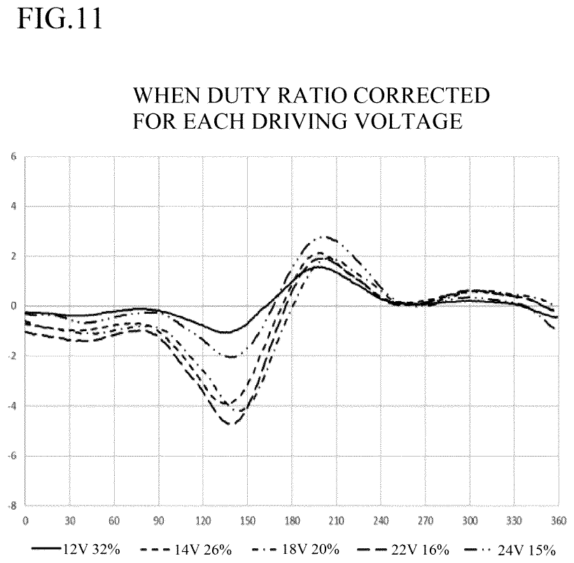

As one example, in the waveform diagram of the induced voltage in the non-energized phase coil when the driving voltage fluctuates with a fixed duty ratio of 20% in FIG. 10, from the graph of a driving voltage of 18V and a duty ratio of 20%, the duty ratio calculated from Equation 2 for this motor is approximately 32% for a driving voltage of 12V, approximately 26% for a driving voltage of 14V, approximately 16% for a driving voltage of 22V, and approximately 15% for a driving voltage of 24V. In the example in FIG. 10, the driving voltage is set to 18 V because the optimal duty ratio (energization time) for the motor depicted in FIG. 10 was determined for a driving voltage of 18 V. Although duty ratio was set at 20% because for the motor depicted in FIG. 10, the changes in the positive and negative induced voltages generated in the non-energized phase are significant and easy to measure, there are no limits on the driving voltage or duty ratio used in the present disclosure. FIG. 11 depicts the waveform of the induced voltage induced in the non-energized phase coil when the duty ratio has been corrected in keeping with such voltage fluctuations. The graph in FIG. 11 depicts that when the duty ratio has been corrected in keeping with fluctuations in the driving voltage, the range of voltage fluctuations will be small for all driving voltages, which improves controllability.

In this way, when the driving voltage fluctuates during low-speed operation through the application of a driving voltage to the three-phase coil with a predetermined duty ratio, Equation 1 below is established

$$Im = V / Rm ( 1 - {e}^{( - \frac{Rm}{Lm} )} t ) \qquad Equation 1$$

and the MPU 51 substitutes the predetermined driving voltage V1 and the energization time t1 calculated from the PWM period and the predetermined duty ratio into Equation 1 to calculate the motor current Im. The control section uses

$$t = ( Lm / Rm ) {log}_{e} ( - V / ImRm - V ) \qquad Equation 2$$

produced by solving Equation 1 for t and substitutes the motor current Im calculated using Equation 1 and the driving voltage V2 that has fluctuated from the driving voltage V1 into Equation 2 to calculate the energization time t2, calculates and updates the duty ratio by dividing the energization time t2 by the PWM cycle, and applies the driving voltage V2 with the updated duty ratio from the output section, the measuring section then measures the energized phase voltage and non-energized phase voltage during an on cycle in the PWM energization to detect the magnetic field magnet position of the motor. By doing so, it is possible to detect the field magnet position of the motor and perform low-speed driving without being affected by fluctuations in the driving voltage.

What is claimed is:

1. A method for detecting a field magnet position of an electric motor,
wherein the electric motor includes:
a rotor with a permanent magnetic field;
a stator including a three-phase coil;
output section for bidirectionally energizing the three-phase coil via a half-bridge inverter circuit;
control section for performing pulse width modulation (hereinafter “PWM”) control of a coil output in response to a command from a higher-level controller, storing energization angle information and energization direction information in units of 60° energization zones that enable continuous rotation, and for performing switching control of the output section based on the stored information to switch an energization state; and
measuring section for performing analog to digital conversion of a three-phase coil voltage and sending the converted voltage to the control section, and
the control section performs, through two-phase fixed energization via the output section, 120° energization, which periodically includes off cycles, in an energization direction where a position where self-excitation stops matches a start position of a 60° energization zone, to drive the motor in a sensorless manner while detecting the field magnet position of the motor through measurement by the measuring section of an energization phase voltage and a non-energization phase voltage during an on cycle during PWM energization,
the method comprising:
the control section calculating, when a driving voltage, which is applied to the three-phase coil with a predetermined duty ratio to drive the motor, has fluctuated and
$$Im = V / Rm ( 1 - {e}^{( - \frac{Rm}{Lm} )} t ) \qquad Equation 1$$
where an inductance of the motor is Lm, a resistance is Rm, a driving voltage is V, an energization time is t, and a motor current is Im, is satisfied,
the motor current Im by substituting a predetermined driving voltage V1 and an energization time t1 calculated from a PWM cycle and a predetermined duty ratio into Equation 1;
the control section uses
$$t = ( Lm / Rm ) {log}_{e} ( - V / ImRm - V ) \qquad Equation 2$$
produced by solving Equation 1 for t to calculate an energization time t2 by substituting the motor current Im calculated by Equation 1 and a driving voltage V2 that has fluctuated from the driving voltage V1 into Equation 2;
the control section calculating and updating the duty ratio by dividing the energization time t2 by the PWM cycle; and
the control section using the output section to drive the motor by applying the driving voltage V2 with the updated duty ratio.
